(19) United States
(12) Patent Application Publication
(10) Pub. No.: US 2005/0098273 A1
(43) Pub. Date: May 12, 2005

(54) Pet furniture barrier

(76) Inventor: James C. DeBoard II, Westerville, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/703,389

(22) Filed: Nov. 7, 2003

(51) Int. Cl. E06B 3/92

(52) U.S. Cl. 160/136; 160/351

(57) ABSTRACT

A storable, expansible, high-rise, pet barrier for preventing pets from accessing furniture. The barrier has a plurality of pivotally joined members expansible to a length at least substantially equal to the front facing width of a section of furniture. In its expanded state, the barrier has members distributed along its width for blocking the entry of a pet and having a height at least substantially equal to the height of the legs of a pet. The barrier has a plurality of hinge connectors joining the members together, the connectors including upper hinge connectors and lower hinge connectors to which converging joined members are pivotally attached. The joined members are collapsible to a compact, side-by-side state for storage.

### CROSS-REFERENCE TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to a pet barrier for keeping pets from accessing an area, and more specifically, for keeping pets from jumping up onto the surface of furniture intended for occupation by a human.

2. Description Of The Related Art

Pet owners understand both the rewards and challenges of having a pet live inside the home. A pet in the house is a protector of the home, but more importantly, a loving companion for an individual or family. Typically, when a pet is first introduced into the home there is a training period. This is a period of time when the pet learns what it can and cannot do within the owner's care. One challenge faced by many pet owners is determining how to keep a pet from gaining access to the furniture. This is challenging because a pet will eventually obey when the owner is at home, but once the owner leaves, the pet disobeys and finds a cozy place to nap on the furniture.

A pet having access to the furniture is also unsanitary. Pets leave behind hair, dander, saliva, dirt, fleas, odors and other germs. These left behind follicles and germs can be especially bothersome to an individual who has an allergy to pets. Additionally, pet hair on the furniture is easily transferred to the clothes of those who sit on the furniture. A pet accessing furniture also increases the wear and tear, which in turn, decreases the life of the furniture.

There are several methods for teaching a pet to keep off the furniture. Some methods are more desirable than others. Traditionally, pet owners have used violence, shouting, or negative discipline methods, which may create an undesirable temperament in the animal. Continued confrontations with these methods between pet and owner may not solve the problem and could lead to the owner having to give up the animal.

Pet owners have also tried to use household devices to deter pets including boxes, crates, plastic tubs, or other bulky items. These household items, though somewhat successful in keeping the pet off the furniture, are very difficult to store in an easily accessible location when not in use. They become cumbersome to move about the room should the owner be at home or have guests and want to use the furniture.

The prior art shows several devices for encouraging pets to stay off household furniture. These include a shocking mat (U.S. Pat. No. 4,949,216 to Djukastein), a furniture protection device (U.S. Pat. No. 5,842,746 to Rogers), and a pet training mat (U.S. Pat. No. 6,095,091 to Byrne).

The electronic shocking mat (U.S. Pat. No. 4,949,216 to Djukastein) provides an unpleasant electrical shock to an animal when it walks over the mat. There are problems associated with the shock mat. For a household that has multiple pets of differing sizes or species this may not be practical. The mat has only one level of shock. Therefore, it could be ineffective for a medium-sized or large dog and may be very painful for a small dog or cat. This device may also be a safety concern for pet owners with small children.

The furniture protection device described in the Rogers Patent (U.S. Pat. No. 5,842,746) has multiple angled surfaces connected with a rope for making it uncomfortable for a pet to rest upon. This device is arranged in a manner in which there are spaces between the angled surfaces. This space may be large enough for a cat or small dog to enter and lay comfortably on the furniture while the device is in place, rendering it useless. Another problem with this device is that it is made of materials typically used in making pet toys. The animal may confuse the device for a rope or toy. Since the device is light weight, it is possible for an animal to pull the device off the furniture and use it as a toy. This would then allow the pet to gain access to the furniture.

The pet training mat described in Byrne (U.S. Pat. No. 6,095,091) uses small spikes to create an uncomfortable resting area for a pet. One problem with this mat is that the mat may not be large enough to cover the desired area. It may become expensive to purchase enough mats to protect each piece of furniture in the owner's home. Additionally, the pet owner may find it difficult to store the spiked mats when not in use.

Therefore, it is an object and feature of the invention to provide a pet barrier for preventing pets from accessing furniture that can be effective when in use and easily stored when not in use.

Another object and feature of the invention is to provide a pet barrier that is adjustable so that a single pet barrier can be used on furniture of differing sizes.

Yet another object and feature of the invention is to provide a pet barrier that is made from materials that are unlike pet toys so that the pet would not be confused as to its use and the barrier would not be harmful to different pets in a multiple pet household.

### BRIEF SUMMARY OF THE INVENTION

The invention is a storable, high rise pet barrier for preventing pets from accessing furniture. The pet barrier has a plurality of pivotally joined members expansible to a length sufficient for blocking the entry of a pet onto the furniture. The barrier, in its expanded state, has the members distributed along its width for blocking the entry of a pet. The pivotally joined members are collapsible to a compact, side-by-side state for storage. With the invention, an expansible structure is expanded across the front of a piece of furniture to a width and height to block the entire front of the furniture from entry by a pet.

### BRIEF DESCRIPTION OF THE SEVERAL VIEWS OF THE DRAWINGS

FIG. 1 is a view in perspective of a preferred embodiment of the present invention.

FIG. 2 is an end view of the embodiment of FIG. 1.

FIG. 3 is a top plan view of the embodiment of FIG. 1.

FIG. 4 is a view in side elevation of the embodiment of FIG. 1.

FIG. 5 is a view in perspective of the embodiment of FIG. 1 installed on a sofa.

FIG. 6 is a view in perspective of the embodiment of FIG. 1 installed on a chair.

FIG. 7 is a view in perspective of the embodiment of FIG. 1 in its collapsed state for storage.

FIG. 8 is an enlarged view in perspective showing the detail of an upper hinge connector and segments of joined members attached to the connector for the embodiment of FIG. 1.

FIG. 9 is an enlarged bottom view of the upper hinge connector illustrated in FIG. 8.

FIG. 10 is an enlarged view in perspective showing the detail of a lower hinge connector and segments of joined members attached to the connector for the embodiment of FIG. 1.

FIG. 11 is an enlarged view in perspective of the lower hinge connector illustrated in FIG. 10.

In describing the preferred embodiment of the invention, which is illustrated in the drawings, specific terminology will be resorted to for the sake of clarity. However, it is not intended that the invention be limited to the specific term so selected and it is to be understood that each specific term includes all technical equivalents, which operate in a similar manner to accomplish a similar purpose.

### DETAILED DESCRIPTION OF THE INVENTION

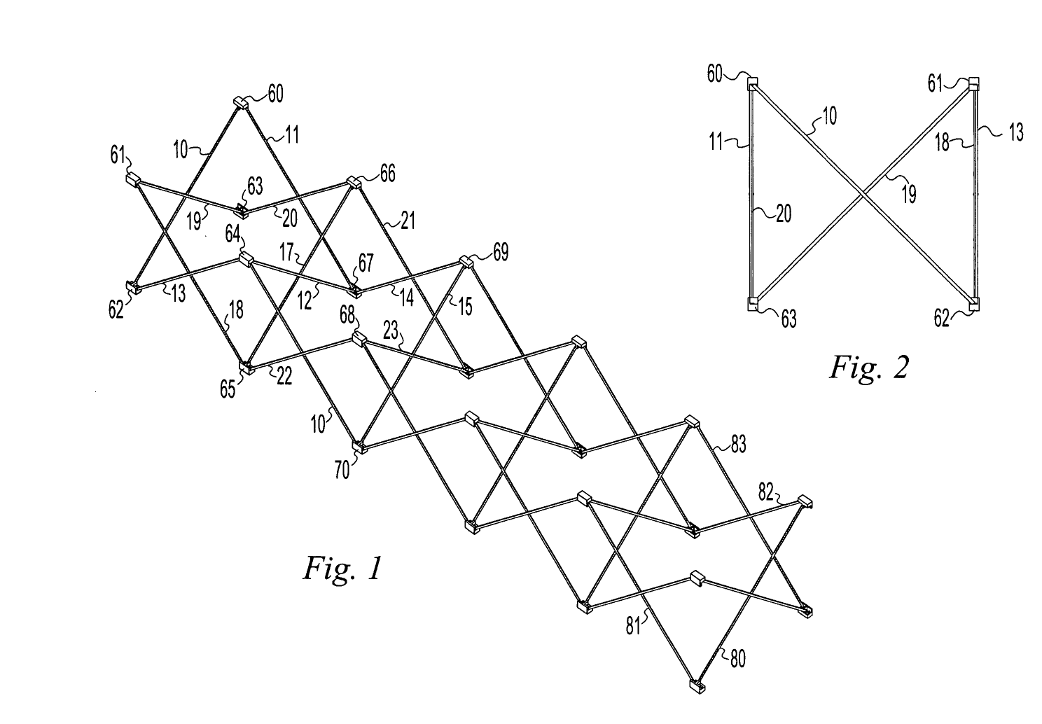

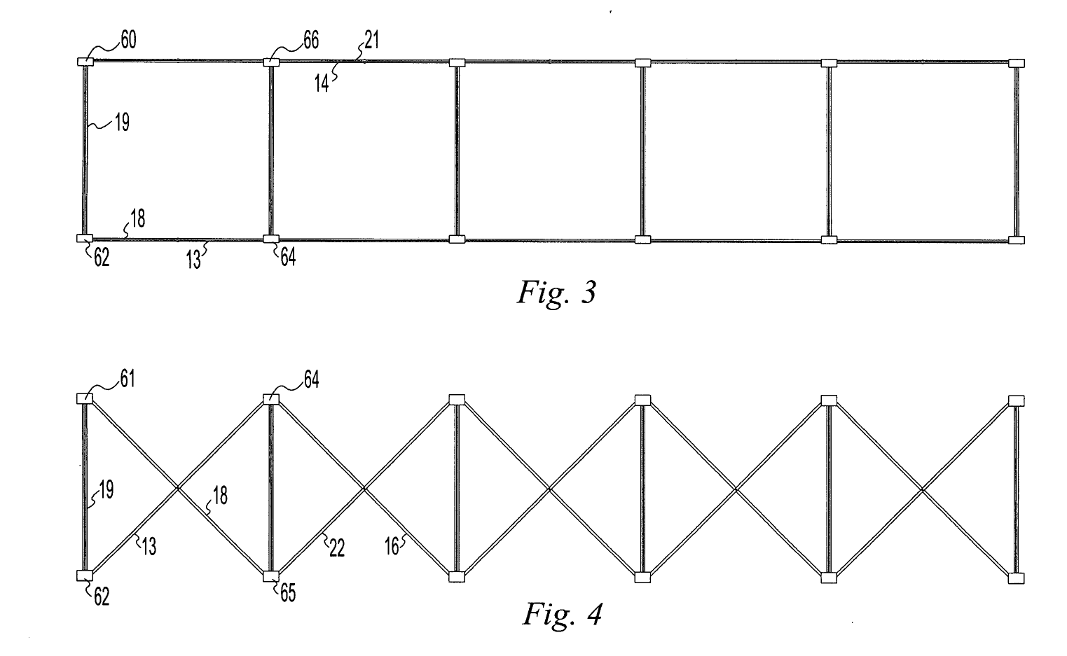

The preferred embodiment of the invention is illustrated in FIGS. 1-7. The invention is a high-rise, pet barrier having pivotally or hingedly joined members, so it can be expanded to a width sufficient to fit across the width of a piece of furniture and can be collapsed to a compact state for convenient storage. The members are distributed along the length of the barrier for blocking the entry of a pet onto the furniture. In an expanded state, the barrier is high rise, that is it has a height to block the entry of the pet, rather than depending upon an uncomfortable surface texture or electric shock to deter a pet from remaining on the surface after contacting the surface. Preferably, it has a height when expanded at least equal to the length of the legs of the pet.

Turning now to the details of the preferred embodiment, a plurality of elongated members are hingedly joined at their ends to converging ends of other members. Adjacent pairs of members are pivotally joined by a pivot pin intermediate their ends. An end member 10 has a upper hinge connector 60, having two cavities (illustrated in FIGS. 9 and 11 and described below) for accepting one end of members joined at the hinge connector, and a lower hinge connector 62, having two cavities for accepting opposite ends of converging members. An intermediate member 11 is pivotally connected to the end member 10 at the upper hinge connector 60. The intermediate member 11 has a second lower hinge connector 67 for connecting to a crosslinking member 12. The crosslinking member 12 has a second upper hinge connector 64 for connecting to an intermediate member 13. The intermediate member 13 is connected to the first lower hinge connector 62, completing the pattern of connection. The connection pattern is replicated a plurality of times to create the preferred embodiment.

The second replication of the pattern has a second intermediate member 14 pivotally connected to the crosslinking member 12 at the second lower hinge connector 67 and to a second crosslinking member 15 at a third upper hinge connector 69. The crosslinking member 15 is connected to a second intermediate member 16 at a third lower hinge connector 70. The second intermediate member 16 is connected to the second upper hinge connector 64 to complete a second replication of the pattern of connection.

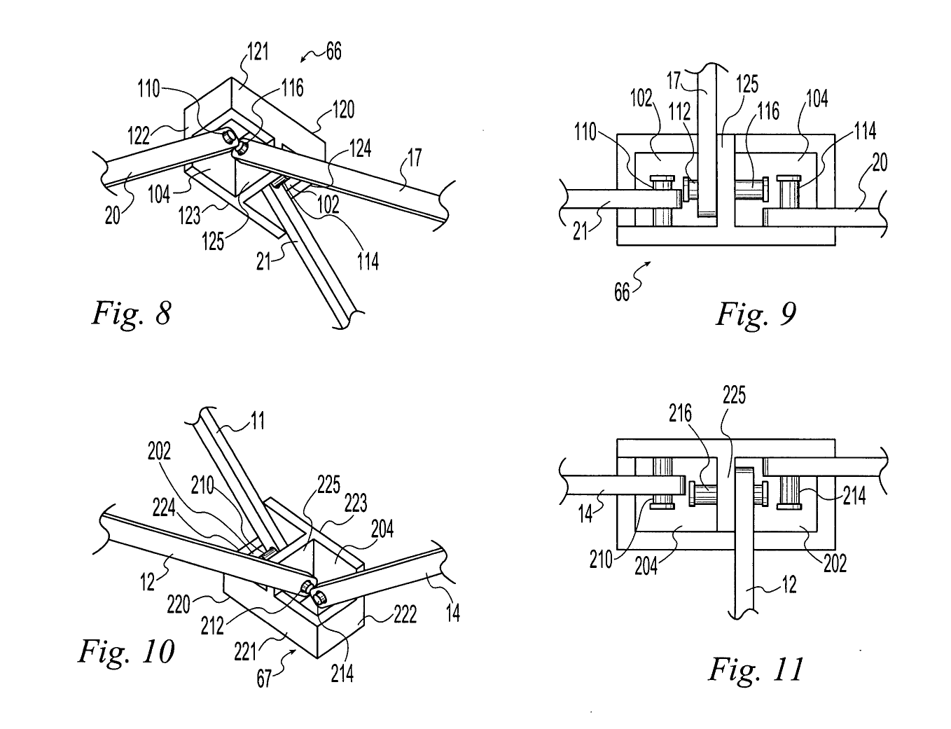

As illustrated in FIG. 8, the upper hinge connector 66, which is representative of the plurality of hinge connectors in the preferred embodiment, is rectangular in shape having four sidewalls 121, 122, 123 and 124 and a top 120. The bottom of the upper hinge connector 66 is open to provide two upper hinge connector cavities 102 and 104, which accept one end of each of the joined members 17, 20 and 21. A center wall 125 divides the upper hinge connector cavities 102 and 104. A pivot pin 116, shown in FIG. 9, is fixed to the center wall 125 and extends through a hole in the end of the crosslinking member 17. Upper hinge connector cavity 104 accepts the end of member 20 and the end of member 17, which pivot about their respective pivot pins 110 and 116 during expansion and collapse of the pet barrier.

FIG. 10 illustrates the lower hinge connector 67, which is representative of the plurality of lower hinge connectors in the preferred embodiment. The lower hinge connector 67 is rectangular in shape having four sidewalls 221, 222, 223 and 224 and a bottom 220. The top of the lower hinge connector 67 is open to provide two lower hinge connector cavities 202 and 204, which accept one end of the converging, joined members 11, 12 and 14. A center wall 225 divides the lower hinge connector cavities 202 and 204. A pivot pin 216 is attached to the center wall 225, as illustrated in FIG. 11, and extends through a hole in the member 12 so that the member 12 can pivot about the pivot pin 216. Similarly, the members 11 and 14 are pivotally connected to their respective pivot pins 214 and 210. The bottom 220 of the lower hinge connectors are preferably substantially flat, which can include a small rounded curvature, for seating on the upper surface of the furniture.

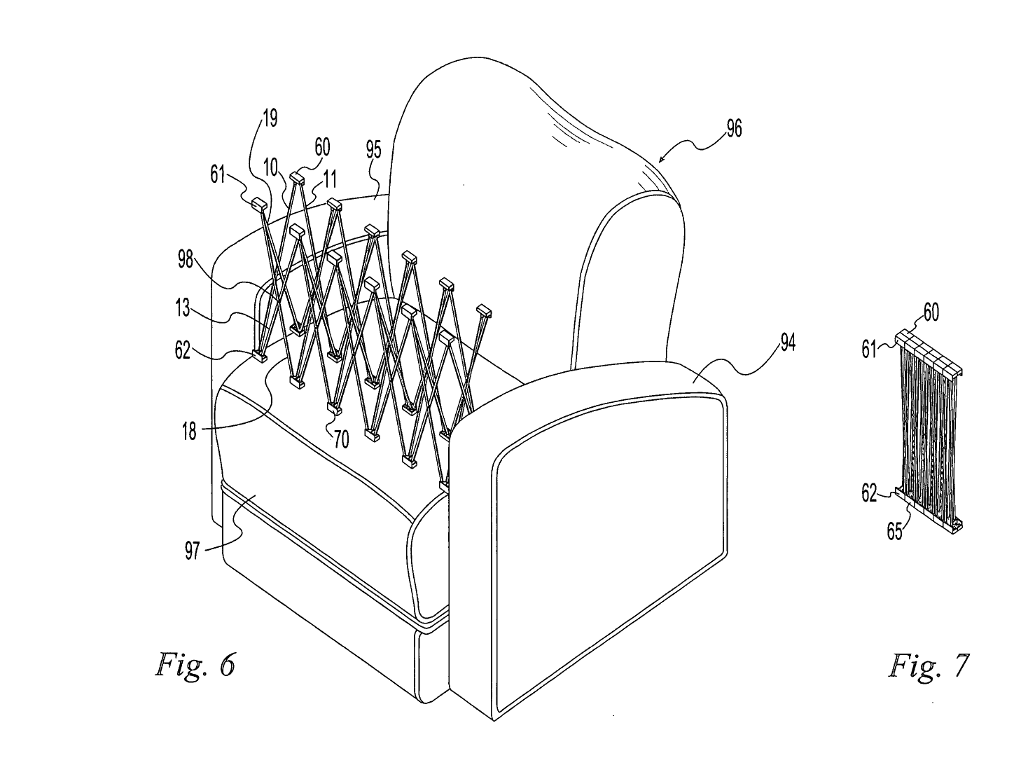

Intermediate the ends of the members, adjacent members are connected by midpoint pivot pins. A midpoint pivot pin 98, shown in FIG. 6, connects the joined members 13 and 18, to permit the expansion and collapse of the barrier. This midpoint pivot is representative of a plurality of midpoint pivots used in the barrier. The midpoint pivot is positioned a selected distance from the opposing ends of the members 13 and 18. The pivot in the preferred embodiment is a pin that connects the adjacent members and rotates about its axis when the barrier is expanded or collapsed. The pivot can be any variety of suitable materials used in pivoting one member about a second member. For example, a rivet, a bolt, a screw, etc. are a few examples of the types of pivots that the person of ordinary skill will recognize as being possible substitutions for pivoting the members within the hinge connectors.

The joined members are preferably made of rods or barstock for easy pivoting within the upper hinge connectors and lower hinge connectors. However, the joined members can be of a variety of other suitable expansible and collapsible members including pleated bellows or a lattice. The rods of the preferred embodiment are made of aluminum, but can be, plastic, steel, or any variety of suitable materials. The upper hinge connector and lower hinge connector are preferably plastic, but also can be aluminum, steel, wood or any variety of suitable material.

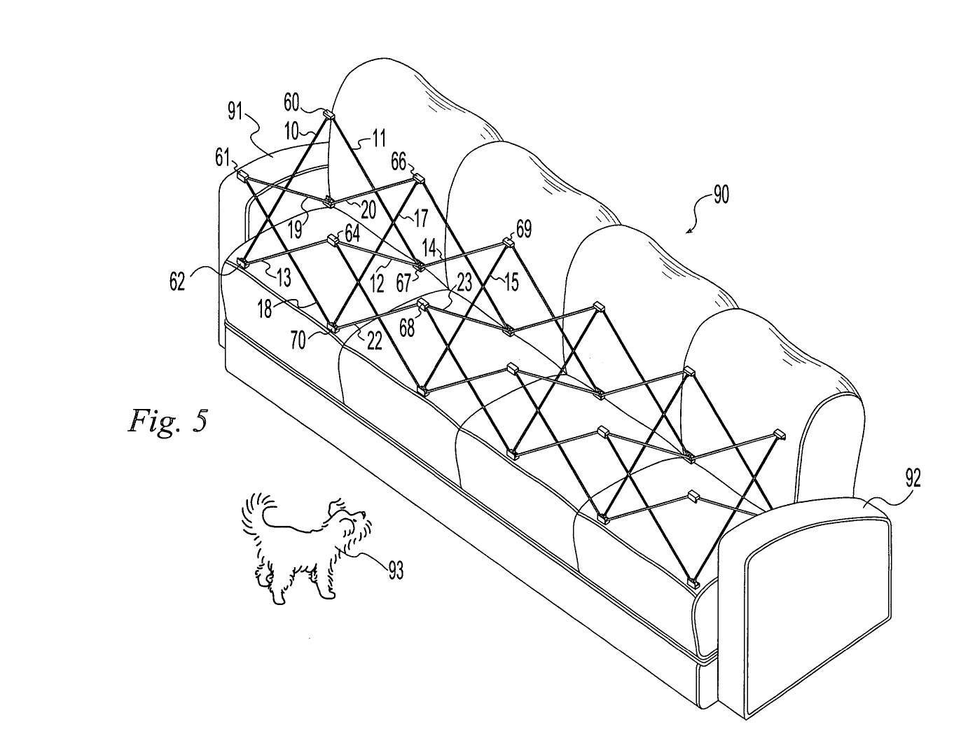

To expand the collapsed pet barrier, the user simply pulls the endmost joined members 10, 11, 18 and 19 in a direction away from the joined members 80, 81, 82 and 83 at the opposite end, although the application of opposite, outwardly directed forces on any two adjacent members will also spread the barrier. Each member pivots within an upper hinge connector and a lower hinge connector to expand outward to a length that substantially equals the front facing width of a section of furniture. The front facing width of a section of furniture is the cushioned section 93 spaced intermediate two arm ends 91 and 92 of the section where humans sit, shown in FIG. 5, or the cushioned section 97 illustrated in FIG. 6. The barrier in its expanded state has members distributed along its width for blocking the entry of a pet. The pet barrier has a height at least substantially equal to the height of the legs of a pet. However, the height of the pet barrier may vary to a height greater then the height of the pet.

To collapse the pet barrier, the user simply pushes the end members toward each other, which collapses the barrier. The joined members pivotally come together into substantially parallel alignment within the upper hinge connectors and lower hinge connectors to return to a side-by-side configuration, shown in FIG. 7. The barrier may be collapsed or expanded to a variety of widths to accommodate any size furniture such as a sofa, shown in FIG. 5, or a chair, shown in FIG. 6.

One advantage of the pet barrier is that the pet does not have to “try it out” before it deters the pet from accessing the furniture. The pet barrier provides a plainly visible barrier between the pet and the furniture not requiring the pet to initiate contact with the device before a negative reaction indicates that it is an area that the pet is not to access. The pet can see the pet barrier, when it is positioned in its operable position and orientation, and this view is enough to deter the pet from attempting to access the furniture.

An additional advantage of the invention is that the pet barrier can be stored in a variety of places around the house. Due to the collapsible configuration, the barrier can be stored in places such as, under a couch or chair, behind a couch or chair, in a closet, or in a small space between furniture. The size of the barrier makes the pet barrier convenient to use and to store at a nearby location, while being effective at keeping pets off furniture.

Various alternative constructions can also embody the present invention. For example, the hinge connectors can be a flexible, molded material, such as one of several types of plastics, to form live hinges for connection to the members. Live hinges are known in the prior art and are typically a unitary or integral, single piece having flexible components which bend to allow relative pivotal movement of structures attached to the components of the live hinge instead of having hinge components which rotate with respect to other hinge components as in a conventional hinge. Furthermore, the members which extend between the hinge connectors can be integrally molded to the live hinges.

While certain preferred embodiments of the present invention have been disclosed in detail, it is to be understood that various modifications may be adopted without departing from the spirit of the invention or scope of the following claims.

1. A storable, high-rise, pet barrier for preventing pets from accessing furniture, the barrier comprising: a plurality of pivotally joined members expansible to a length at least substantially equal to the front facing width of a section of furniture, the barrier, in its expanded state having the members distributed along its width for blocking the entry of a pet, the joined members being collapsible to a compact, side by side state for storage.

2. A barrier according to claim 1, further comprising connectors joining the members together, said connectors being a upper hinge connector and a lower hinge connector to which said members are pivotally attached, the hinge connectors allowing movement of said members from a collapsed configuration to an extended configuration.

3. A barrier according to claim 2, further comprising a plurality of replications of said joined members and connectors in a repeating pattern for a selected distance at least substantially equal to the front facing width of a section of furniture.

4. A barrier according to claim 2, wherein adjacent members are pivotally joined together intermediate their ends.

5. A barrier according to claim 4, wherein said lower hinge connectors acts as support feet, having at least one flat end for seating against a surface.

6. A barrier according to claim 5, wherein said members are pivotally connected by midpoint pivots, as well as being pivotally connected at said upper hinge connector and said lower hinge connector so that the barrier expands or contracts as a whole.

7. A barrier according to claim 6, wherein said midpoint pivots are rivets.

8. A storable, high-rise, pet barrier for preventing pets from accessing furniture, the barrier comprising:
a. a plurality of pivotally joined members expansible to a length at least substantially equal to the front facing width of a section of furniture, the barrier, in its expanded state, having the members distributed along its width for blocking the entry of a pet, the barrier having a height at least substantially equal to the height of the legs of the pet, the joined members being pivotally connected by midpoint pivots so that the barrier expands or contracts as a whole and is collapsible to a compact, side by side state for storage; and
b. a plurality of hinge connectors joining the members together, said connectors including upper hinge connectors and a lower hinge connectors to which said joined members are pivotally attached.

9. A barrier according to claim 8, further comprising a plurality of replications of said joined members and connectors in a repeating pattern for a selected distance at least substantially equal to the front facing width of a section of furniture in an expanded state.

10. A barrier according to claim 8, wherein said lower hinge connectors act as support feet, having at least one flat end for seating against a surface, said lower hinge connectors being movable generally towards a central area as said members move from said extended configuration towards a collapsed configuration.

11. A barrier according to claim 10, wherein the hinge connectors include pins that pivotally engage the members.

12. A barrier according to claim 11, wherein said midpoint pivots are rivets.

13. A barrier according to claim 8, wherein said members are rods.

14. A method for preventing a pet from accessing furniture, the method comprising:
expanding an expansible structure across the front of a piece of furniture to a width and height to block the entire front of the furniture from entry by a pet.
